(19) United States
(12) Patent Application Publication
(10) Pub. No.: US 2016/0300023 A1
(43) Pub. Date: Oct. 13, 2016

(54) PROVIDER RATING SYSTEM

(71) Applicant: Aetna Inc., Hartford, CT (US)

(72) Inventor: Patrick Leonard, Littleton, CO (US)

(21) Appl. No.: 14/683,811

(22) Filed: Apr. 10, 2015

(51) Int. Cl. G06F 19/00; G06Q 30/02; G06F 17/30

(52) U.S. Cl. CPC G06F 19/327; G06F 17/30625; G06F 17/30684; G06Q 30/0201; G06Q 30/0282

(57) ABSTRACT

System and methods for generating provider quality ratings are described. One exemplary method includes establishing, with a collection processor, a listing of locations containing user comments relating to a plurality of providers. The collection processor collects user comments relating to a provider from the listing of locations. The user comments are normalized and stored in a normalized user comment database. Next, a natural language processor analyzes the normalized user comments using sentiment analysis. A provider rating is determined from the sentiment analysis provider rating and transmitted to a display device.

### BACKGROUND

Providing consumers with a complete and accurate representation of the quality of providers is not possible. Many systems and methodologies exist for rating providers. For example, healthcare providers may be measured based on cost, quality of care or the network with which they are associated. Additionally, consumers may rate healthcare providers using a number of Internet resources and locations. In some instances, consumers may comment on healthcare providers on the Internet, but not provide any type of rating that can easily be viewed.

In one example, a website may allow users to comment on a particular provider, such as a doctor. Users can go to the website and describe their experiences with the provider by writing comments. The comments can address any aspect of the provider, including quality of care, costs, wait times to see the provider and other issues that the user feels are pertinent. However, in order for a consumer considering using the provider to evaluate the provider, the consumer has to search for the website and read through all of the posted comments. Further, many such websites exist. To get a complete understanding of user comments, the consumer would have to go to each such website to read comments.

Additional sources of information regarding a provider's network, such as a doctor's provider network ratings would also need to be checked. Additionally, a consumer may also want to check a doctor's history with a particular procedure. It is very difficult for consumers to review and evaluate all of the disparate sources of information.

### BRIEF SUMMARY

In one embodiment, the disclosure provides a method for generating provider quality ratings. The method includes establishing, with a collection processor, a listing of locations containing user comments relating to a plurality of providers. Next, the collection processor collects user comments relating to a provider from the listing of locations. The user comments are normalized, with a normalization processor, by matching demographic information from the locations of the user comments with information stored in a provider database. The normalized user comments including matched providers are stored in a normalized user comment database. Next, a natural language processor analyzes the normalized user comments using sentiment analysis to determine a sentiment analysis provider rating. A provider rating is determined from the sentiment analysis provider rating and the provider rating for a particular provider is transmitted to a display device.

In another embodiment, the disclosure provides a provider quality ratings system. The system includes at least one computer processor and a memory coupled with and readable by the at least one computer processor and comprising a series of instructions that, when executed by the at least one computer processor, cause the at least one computer processor to execute instructions. The memory includes instructions to establish a listing of locations containing user comments relating to a plurality of providers. There are instructions to collect user comments relating to a provider from the listing of locations. The memory further includes instructions to normalize the user comments by matching demographic information from the locations of the user comments with information stored in a provider database. There are instructions to store the normalized user comments including matched providers in a normalized user comment database. There are instructions to analyze the normalized user comments using sentiment analysis to determine a sentiment analysis provider rating. The memory includes instructions to determine a provider rating from the sentiment analysis provider rating and transmit the provider rating for a particular provider to a display device.

In another embodiment, the disclosure provides a non-transitory computer readable medium having stored thereon computer executable instructions for generating provider quality ratings. There are instructions for performing a number of steps. The steps include establishing, with a collection processor, a listing of locations containing user comments relating to a plurality of providers. Next, the collection processor collects user comments relating to a provider from the listing of locations. The user comments are normalized, with a normalization processor, by matching demographic information from the locations of the user comments with information stored in a provider database. The normalized user comments including matched providers are stored in a normalized user comment database. Next, a natural language processor analyzes the normalized user comments using sentiment analysis to determine a sentiment analysis provider rating. A provider rating is determined from the sentiment analysis provider rating and the provider rating for a particular provider is transmitted to a display device.

### BRIEF DESCRIPTION OF THE SEVERAL VIEWS OF THE DRAWING(S)

FIG. 1 is a block diagram of a system for generating provider quality ratings according to one embodiment of the disclosure;

FIG. 2 is a block diagram of a system for collecting public user sentiment, according to one embodiment of the disclosure;

FIG. 3 is a diagram showing one process for performing sentiment analysis according to one embodiment of the disclosure;

FIG. 4 illustrates an interface for viewing providers ratings according to one embodiment;

FIG. 5 illustrates a flow chart for generating provider quality ratings according to one embodiment; and

FIG. 6 is a block diagram of a processing system according to one embodiment.

### DETAILED DESCRIPTION OF THE INVENTION

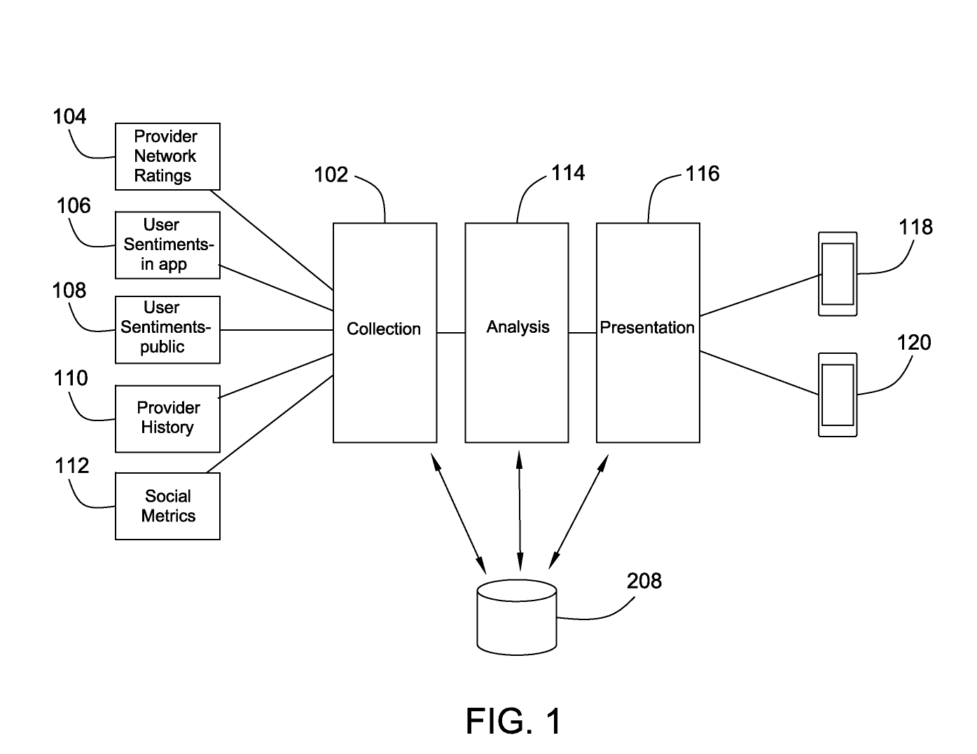

FIG. 1 is a block diagram of a system for generating provider quality ratings according to one embodiment. Providers can be any type of service or good provider. In one embedment, the provider is a healthcare provider, such as a doctor. It is currently very difficult for consumers to evaluate a doctor. Information is available from a wide variety of sources. Additionally, some information is only available in prose form. For example, some websites allow users to write reviews of providers. These sites may or may not allow a user to leave a numerical score. Even if a numerical score was left for a provider, it may not be clear what aspect of the provider's services influenced the score. A consumer would have to read through all of the comments on the website for a particular provider in order to evaluate the provider.

FIG. 1 provides a system for generating provider quality ratings. A collection processor 102 gathers information from a variety of sources. One source of information is provider network ratings 104. For example, a healthcare provider, such as a doctor, may be associated with a healthcare network. Ratings for healthcare networks are available from a variety of sources and websites. Information from these sources for provider network ratings 104 are collected by the collection processor 102.

The collection processor 102 also collects user sentiments. In one embodiment, an application or website is provided to consumers. A consumer can then use the application or website to write a review or comment on a provider. The collection processor then gathers these in-app user sentiments 106. As described below, the system then analyzes the comments to determine an overall sentiment for the provider. The collection processor 102 also gathers public user sentiment 108 information. This information can come from public websites and is gathered through direct links with public websites and/or using a web crawler to gather information. The collection processor 102 also collects information regarding a provider's history. For example, a doctor's history with a particular procedure is gathered. The history with a procedure includes the number of times the procedure was performed, history of complications and any conflicts of interest such as consulting to device manufacturers. This information can be gathered from specialized industry websites and sources. Additionally, the collection processor 102 can crawl social websites to gather additional social metrics 112 relating to a provider.

In an embodiment where the provider is a doctor, information such as board certifications, referrals, publications and citations to the publications by others can all be gathered by the collection processor 102. This information can come from the provider history 110 source and other specialized and general interest sources on the Internet.

After information is collected by the collection processor 102, the information is analyzed by the analysis processor 114. As described below, the analysis processor assigns a score to each piece of information. Each individual score is then combined to create a composite provider rating. After the ratings are generated, a presentation processor 116 can the present the scores and additional information to display devices 118 and 120. The display devices include computers, phones, tablet computers and other devices configured for receiving and displaying data.

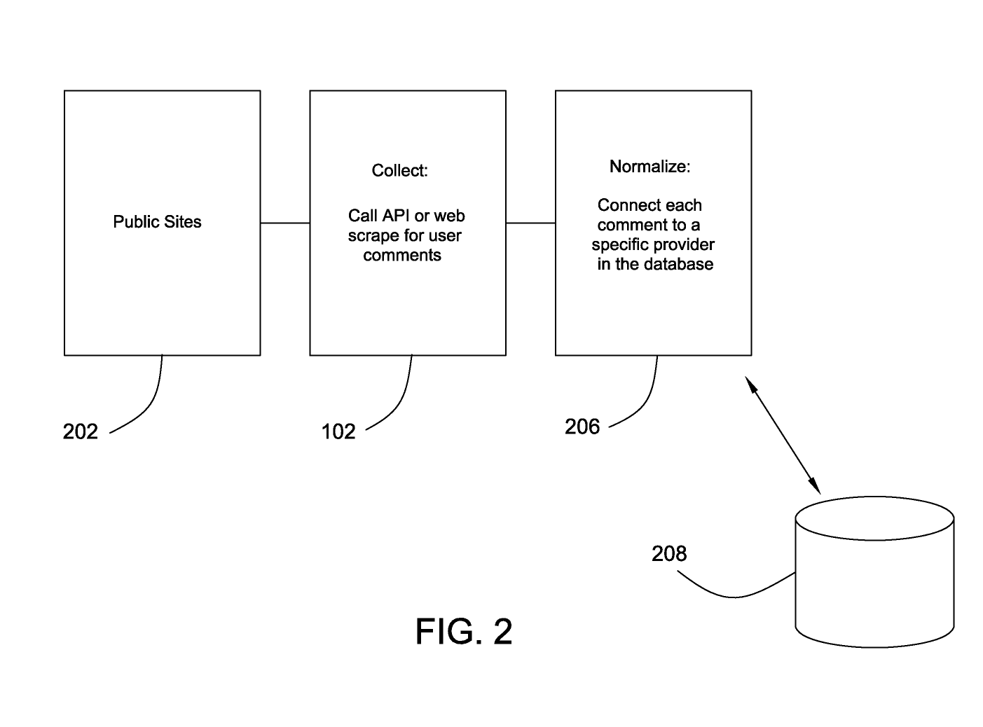

FIG. 2 is a block diagram of a system for collecting public user sentiment, according to one embodiment of the disclosure. FIG. 2 illustrates processing elements for collecting public user sentiment 108 information. The collection processor 102 connects to a list of public sources of information 202. The list includes websites and other sources of information that public information should be collected from. For example, publicly accessible websites that are likely to contain user comments on particular providers are contained in the list. The list of public sources of information 202 can be pre-populated. The collection processor 102 then uses application programming interfaces (APIs) to collect comments, reviews and other information posted by consumers on the websites in the list of public sources of information 202. Alternatively, the collection processor can use a web crawler or web scraper to collect comments, reviews and other information posted by consumers on the websites in the list of public sources of information 202. For some websites the collection processor may use an API and use a web crawler or web scraper for other sites.

After the collection processor 102 collects public user sentiment, a normalization processor 206 connects each comment to a specific provider. The normalization processor connects to a provider database 208. The provider database 208 contains a listing of known providers. The normalization processor 206 therefore connects each comment to a specific provider in the provider database 208.

Normalization ensures that comments can be positively connected to a specific provider. This can be done by matching a combination of demographic information (name, address, phone) collected with the collection processor 102 with the information in the provider database 208. In one embodiment, this is accomplished by calculating a confidence score for each provider to be matched. For example, each of a number of data elements from a provider record from the collection processor 102 is matched to corresponding data elements in a provider record in the provider database 208. For each data element (such as name, address, phone), a confidence score is calculated using a method such as Levenshtein distance. After matching all data elements, an aggregate confidence score can be calculated to determine if the provider record is a match. For each matching provider record, the comments are updated in the corresponding provider record in the provider database 208. In this way, the provider database maintains a copy of the comments that were collected and normalized to a specific provider. For sources of information with a known provider, such as app user sentiments, the normalization processor performs a look up to the database. App user sentiments are known because a user selects a provider in the application in order to post comments and reviews.

Likewise, in some embodiments, the provider database stores other information generated by the collection processor. The provider database 208 can store provider history, provider network ratings, board certifications, referrals, publications and citations to the publications by others in addition to other data relating to a provider. The provider database also stores user sentiment for a provider from the sentiment analysis, as described below.

The analysis processor 114 determines scores for information collected by the collection processor 102 and data in the provider database 208. For example, a provider with extensive history with a particular procedure will receive a higher score for history with a procedure then a provider with little or no history with the procedure. Likewise, providers with no of few complications with a procedure will receive a higher score for that aspect than providers with many complications for a given procedure. Providers with many publications and/or many citations to their publications will receive a higher score then providers with no publications or few publications and few citations. The scores can be any numerical or other system. In one embodiment, the scores are between 1 and 5 with 5 being the highest score for a particular procedure.

The analysis processor 114 uses a natural language processing (NLP) system to infer a sentiment rating from public user sentiments 108 and in application user sentiments 106 that have been gathered by the collection processor 102. The comments can be passed directly to the analysis processor 114 or saved in the provider database 208. The analysis processor can then gather the comments from the provider database 208. Sentiment analysis is used to convert the user sentiment to a rating.

In one embodiment, binary trees are used to perform sentiment analysis. The NLP system is capable of analyzing sentiments at multiple levels, including document, sentence and aspect. Document-level analysis is used to analyze the intent of a review or comment. Sentence-level analysis is used to determine whether an individual sentence has different sentiment from the overall review or comment. For example, a patient may have an overall favorable view of a doctor but in a particular sentence may have a negative comment about something specific, such as waiting too long to be seen. The sentence may be considered independent of the document as long as the relationship with the entity (in this case the healthcare provider) is maintained. Aspect-level analysis is used to go directly to the opinion in relation to the entity (in this case the healthcare provider). This allows for a more detailed understanding of the patient's opinion. For example, “the doctor correctly diagnosed my problem but he was rude and dismissive” conveys an opinion about two different aspects of the entity. These are understood independently. The NLP system is trained with words and phrases that are relevant in order to make it accurate for use.

There are multiple approaches that can be used for sentiment analysis. For example, a scoring system could include both objective and emotional scoring of words. In such a system, the following scores are assigned: −2 negative emotional, −1 negative no emotion, 0 neutral, +1 positive no emotion, and +2 positive emotional. In this system, an emotional comment increases the positive or negative score. In an alternative embodiment, sentiment trees focus on sentiment classification across phrases without regard to emotion. The following classifications are used: −2 very negative, −1 negative, 0 neutral, +1 positive, and +2 very positive.

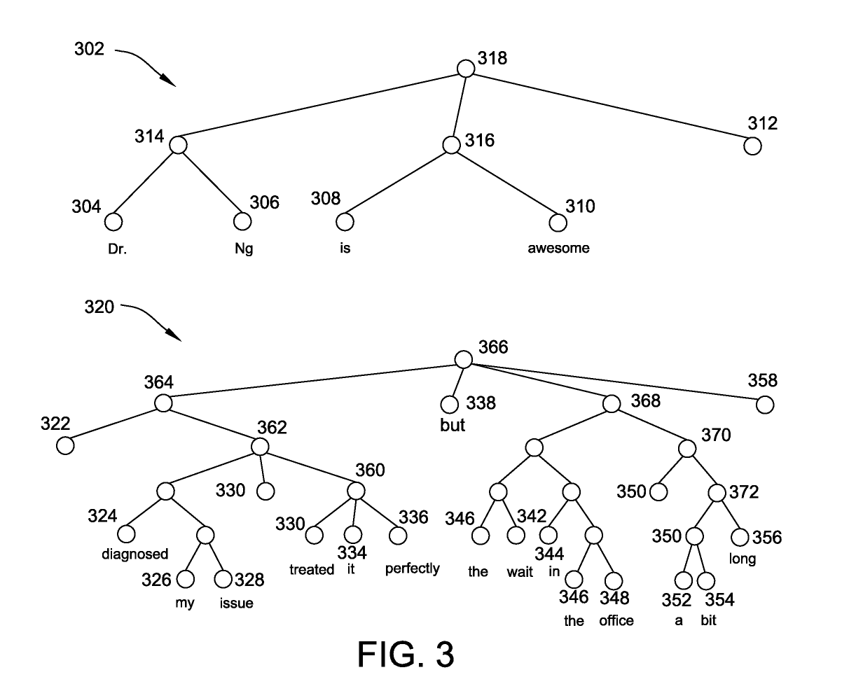

FIG. 3 is a tree diagram showing one process for performing sentiment analysis according to one embodiment of the disclosure. This example uses the objective and emotional scoring system. The sentences “Dr. Ng is awesome! He diagnosed my issue and treated it perfectly but the wait in the office was a bit long.” are analyzed.

Each sentence is individually analyzed. The first sentence, “Dr. Ng is awesome!” is placed into a tree 302. Each word of the sentence and the exclamation mark are placed at nodes as follows: “Dr.” 304 “Ng” 306 “is” 308 “awesome” 310 “!” 312. Nodes 304 and 306 receive a score of 0 because the words “Dr.” and “Ng” are neutral. The combined score at node 314 is the average of nodes 304 and 306 and is also 0. Node 308 also receives a score of 0 because the word “is” is also neutral. Node 310 receives a score of 2 or ++ because the word “awesome” indicates positive emotion. Node 316 is the average of nodes 308 and 310 and is 1 or +. Finally, node 312 receives a score of 2 or ++ because the exclamation point is positive emotion. The score for Nodes 314, 316 and 312 is averaged. The final score for the sentence “Dr. Ng is awesome!” receives a score of 1 or + based on the average of nodes 314, 316 and 312.

The second sentence “He diagnosed my issue and treated it perfectly but the wait in the office was a bit long.” is analyzed in a tree. Once again, each word in the sentence and the punctuation mark are placed at the end nodes in the tree as follows: “He” 322 “diagnosed” 324 “my” 326 “issue” 328 “and” 330 “treated” 332 “it” 334 “perfectly” 336 “but” 338 “the” 340 “wait” 342 “in” 344 “the” 346 “office” 348 “was” 350 “a” 352 “bit” 354 “long” 356 “.” 358. Each of nodes 322, 324, 326, 326, 330, 332 and 334 receive a score of 0 because the associated words are neutral. Node 336 receives a score of 2 or ++ because the word “perfectly” indicates positive emotion. Nodes 360, 362 and 364 are averages of their subnodes. Node 364 receives a score of 1 or + because the average sentiment is greater than 0 and the score is rounded up. Node 338 is associated with the word “but.” Because “but” is a transitional word, trees are formed to the left of it and to the right of it. Node 338 connects directly to the parent node 366. Node 338 receives a score of 0 because the word “but” is neutral. Likewise, nodes 340, 342, 344, 346, 348, 350, 352, and 354 receive a score of 0 because the associated words are neutral. Node 356 receives a −1 or − because the word “long” is classified as negative no emotion. Finally, node 358 receives a score of 0 because the period is neutral.

Nodes 368, 370 and 372 are averages of their subnodes. Node 368 receives a score of −1 or − as the average sentiment is less than 0 and the score is rounded down. Finally, node 366 receives a score of +1 or +because the average of the tree is greater than 0 and the score is rounded up. As each node is scored, the actual average is also maintained in addition to the rounded score.

Sentiment analysis can be performed based on comments and reviews from websites or comments and reviews entered into an application. The comments often represent how patients felt about their overall experience with a provider, which may or may not reflect clinical outcomes. People value customer service in healthcare, as in other industries, in addition to clinical outcomes. A person may, for example, tell friends not to go to a doctor because the personal interaction was bad or they waited an hour to be seen, even though the doctor may be clinically excellent.

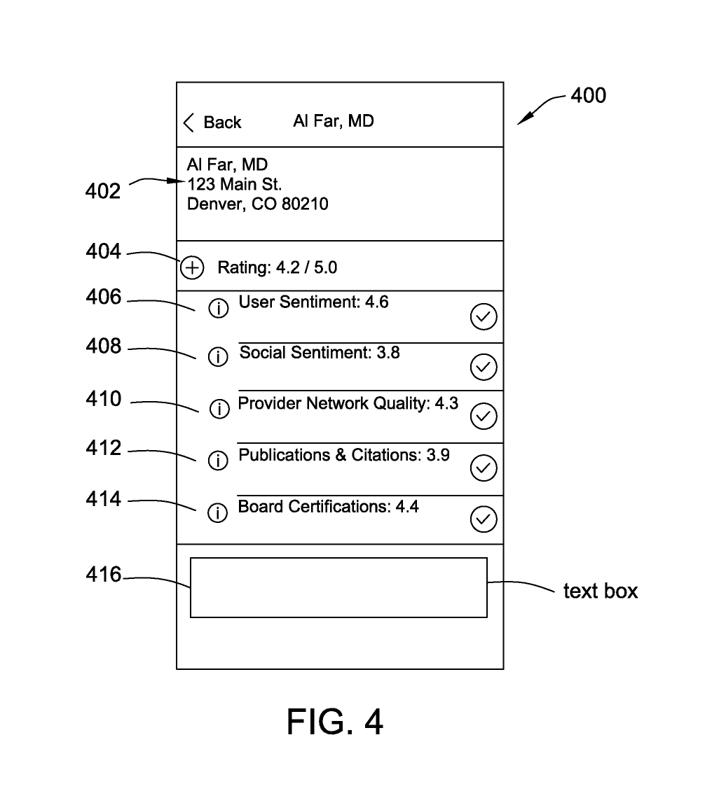

Each of the individual scores is combined to determine an overall provider rating. FIG. 4 illustrates an interface for viewing providers' ratings according to one embodiment. The interface can be implemented within a mobile application, computer application, web interface or other location. The interface 400 shows ratings for Al Far, MD. The provider's name and address are provided in field 402. Field 404 provides the overall provider rating. The user sentiment rating 406 is the score determined using sentiment analysis from users of the application. For example, interface 400 may include a text box 416 for users to leave comments and reviews of the provider. Sentiment analysis would then be performed on the comments and reviews. Social sentiment rating 408 is the score determined from the public user sentiment 108 collection and analysis. Provider network rating 410 is the score determined based on the provider network rating. The provider network rating can be gathered directly from sources that rate provider networks. Additionally, provider network ratings can be determined based on public user sentiment and in-app user sentiment and subject to sentiment analysis as described above with respect to providers. Publication and citation rating 412 is based on the score determined for a provider based on the number of publications attributed to a provider and citations to those publications. Additionally, board certification rating 414 is based on the certifications held by a provider. While the above embodiments are particular to healthcare providers, any provider of goods and services can be evaluated and rated in a similar manner.

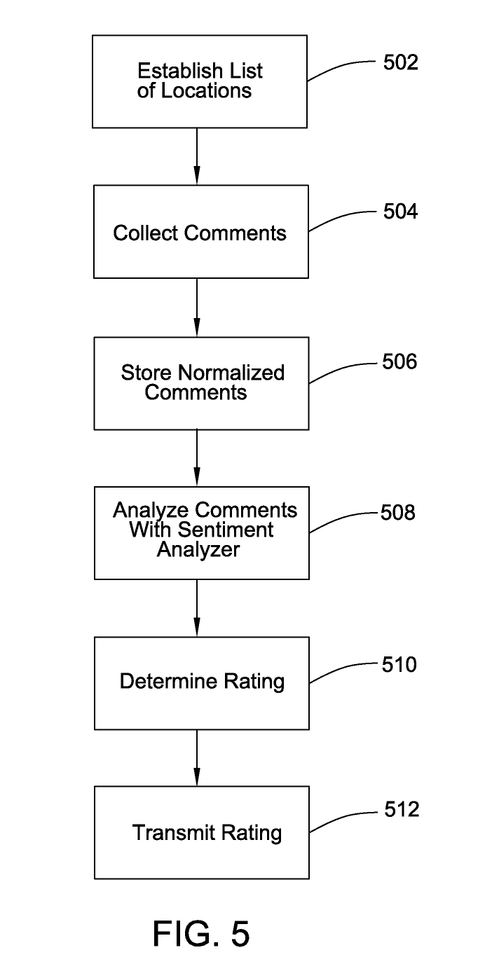

FIG. 5 illustrates a flow chart for generating provider quality ratings according to one embodiment. The method illustrated in FIG. 5 includes at step 502 establishing, with a collection processor, a listing of locations containing user comments relating to a plurality of providers. Next, at step 504, the collection processor collects user comments relating to a provider from the listing of locations. At step 506, the user comments are normalized, with a normalization processor, by matching demographic information from the locations of the user comments with information stored in a provider database. The comments can include reviews, notes and other text relating to a user's interaction with a provider. The normalized user comments including matched providers are stored in a normalized user comment database at step 508. Next, at step 510 a natural language processor analyzes the normalized user comments using sentiment analysis to determine a sentiment analysis provider rating. At step 510, a provider rating is determined from the sentiment analysis provider rating and at step 512 the provider rating for a particular provider is transmitted to a display device.

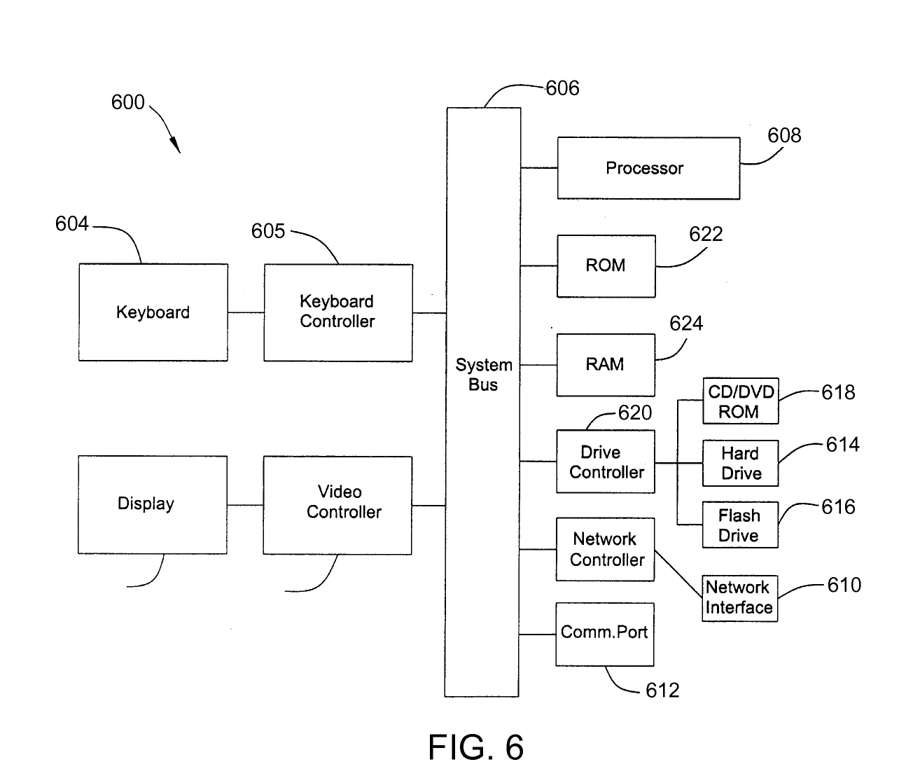

FIG. 6 is a schematic diagram showing hardware components of a system for generating provider quality ratings according to one embodiment. Those skilled in the art will realize that the system for generating provider quality ratings illustrated in FIG. 1 may include one or more computing devices described herein. The computing device 600, such as a computer, includes a plurality of hardware elements, including a display 602 and a video controller 603 for presenting to the user an interface for interacting with the system. The computing device 600 further includes a keyboard 604 and keyboard controller 605 for relaying the user input via the user interface. Alternatively or in addition, the computing device 600 includes a tactile input interface, such as a touch screen. The display 602 and keyboard 604 (and/or touch screen) peripherals connect to the system bus 606. A processor 608, such as a central processing unit (CPU) of the computing device or a dedicated special-purpose support management processor, executes computer executable instructions comprising embodiments of the system for generating provider quality ratings, as described above. In embodiments, the computer executable instructions are received over a network interface 610 (or communications port 612) or are locally stored and accessed from a non-transitory computer readable medium, such as a hard drive 614, flash (solid state) memory drive 616, or CD/DVD ROM drive 618. The computer readable media 614-618 are accessible via the drive controller 620. Read Only Memory (ROM) 622 includes computer executable instructions for initializing the processor 608, while the Random Access Memory (RAM) 624 is the main memory for loading and processing instructions executed by the processor 608. The components illustrated in FIG. 1 can be implemented in one computing device or multiple computing devices connected over a network. Additionally, the user may also use hardware components such as those illustrated in FIG. 6.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for generating provider quality ratings, the method comprising:
establishing, with a collection processor, a listing of locations containing user comments relating to a plurality of providers;
collecting, with the collection processor, user comments relating to a provider from at least one location in the listing of locations;
normalizing, with a normalization processor, the user comments by matching demographic information from the locations of the user comments with information stored in a provider database;
storing the normalized user comments including matched providers in a normalized user comment database;
analyzing, with a natural language processor, the normalized user comments using sentiment analysis to determine a sentiment analysis provider rating;
determining a provider rating from the sentiment analysis provider rating; and
transmitting the provider rating for a particular provider to a display device.

2. The method of claim 1 further comprising:
collecting, with the collection processor, provider network ratings;
associating the provider network ratings with providers stored in the provider database; and
wherein the determining a provider rating step further comprises determining a provider rating from the provider network ratings.

3. The method of claim 2 further comprising:
collecting, with the collection processor, provider history with a procedure data;
associating the provider history with a procedure data with providers stored in the provider database;
determining a provider history rating from the provider history with a procedure data; and
wherein the determining a provider rating step further comprises determining a provider rating from the provider history rating.

4. The method of claim 1 wherein the analyzing, with a natural language processor, step further comprises determining the sentiment analysis provider rating by analyzing sentiment at a document, sentence and word level.

5. The method of claim 1 wherein the analyzing, with a natural language processor, step further comprises traversing a binary tree.

6. The method of claim 1 wherein the listing of locations includes at least one publicly available website.

7. The method of claim 1 wherein the listing of locations includes at least one website with restricted access.

8. The method of claim 1 wherein the collecting, with the collection processor, user comments step is performed periodically.

9. A provider quality ratings system, the system comprising:
at least one computer processor; and
a memory coupled with and readable by the at least one computer processor and comprising a series of instructions that, when executed by the at least one computer processor, cause the at least one computer processor to:
establish a listing of locations containing user comments relating to a plurality of providers;
collect user comments relating to a provider from the listing of locations;
normalize the user comments by matching demographic information from the locations of the user comments with information stored in a provider database;
store the normalized user comments including matched providers in a normalized user comment database;
analyze the normalized user comments using sentiment analysis to determine a sentiment analysis provider rating;
determine a provider rating from the sentiment analysis provider rating; and
transmit the provider rating for a particular provider to a display device.

10. The system of claim 9 wherein the memory further comprises a series of instructions that, when executed by the at least one computer processor, cause the at least one computer processor to:
collect provider network ratings;
associate the provider network ratings with providers stored in the provider database; and
wherein the determine a provider rating instructions further comprise instructions for determining a provider rating from the provider network ratings.

11. The system of claim 10 wherein the memory further comprises a series of instructions that, when executed by the at least one computer processor, cause the at least one computer processor to:
collect provider history with a procedure data;
associate the provider history with a procedure data with providers stored in the provider database;
determine a provider history rating from the provider history with a procedure data; and
wherein the determine a provider rating instructions further comprise instructions to determine a provider rating from the provider history rating.

12. The system of claim 9 wherein the analyze instructions further comprise instructions to determine the sentiment analysis provider rating by analyzing sentiment at a document, sentence and word level.

13. The system of claim 9 wherein the analyze instructions further comprise instructions to traverse a binary tree.

14. The system of claim 9 wherein the listing of locations includes at least one publicly available website.

15. The system of claim 9 wherein the listing of locations includes at least one website with restricted access.

16. A non-transitory computer readable medium having stored thereon computer executable instructions for generating provider quality ratings, the instructions comprising:
establishing, with a collection processor, a listing of locations containing user comments relating to a plurality of providers;
collecting, with the collection processor, user comments relating to a provider from the listing of locations;
normalizing, with a normalization processor, the user comments by matching demographic information from the locations of the user comments with information stored in a provider database;
storing the normalized user comments including matched providers in a normalized user comment database;
analyzing, with a natural language processor, the normalized user comments using sentiment analysis to determine a sentiment analysis provider rating;
determining a provider rating from the sentiment analysis provider rating; and
transmitting the provider rating for a particular provider to a display device.

17. The computer readable medium of claim 16, the instructions further comprising:
collecting, with the collection processor, provider network ratings;
associating the provider network ratings with providers stored in the provider database; and
wherein the determining a provider rating step further comprises determining a provider rating from the provider network ratings.

18. The computer readable medium of claim 17, the instructions further comprising:
collecting, with the collection processor, provider history with a procedure data;
associating the provider history with a procedure with providers stored in the provider database;
determining a provider history rating from the provider history with a procedure data; and
wherein the determining a provider rating step further comprises determining a provider rating from the provider history rating.

19. The computer readable medium of claim 16 wherein the analyzing, with a natural language processor, step further comprises determining the sentiment analysis provider rating by analyzing sentiment at a document, sentence and word level.

20. The computer readable medium of claim 16 wherein the listing of locations includes at least one publicly available website.
